(19) United States
(12) Patent Application Publication
(10) Pub. No.: US 2011/0109644 A1
(43) Pub. Date: May 12, 2011

(54) SYSTEM AND METHOD FOR PERFORMING MOTION CONTROL WITH DISPLAY LUMINANCE COMPENSATION

(75) Inventor: Yoeri Geutskens, Nuenen (NL)

(73) Assignee: NXP B.V., Eindhoven (NL)

(21) Appl. No.: 13/054,446

(22) PCT Filed: Jul. 16, 2009
(86) PCT No.: PCT/IB2009/053076

§ 371 Date: Jan. 17, 2011

Related U.S. Application Data
(60) Provisional application No. 61/081,322, filed on Jul. 16, 2008.

(51) Int. Cl. G09G 5/02

(52) U.S. Cl. 345/589

(57) ABSTRACT

A system and method for performing motion control measures an effect of luminance variations of a display on captured image data containing motion information with regard to brightness and adjusts the brightness of the image data to compensate the effect of the luminance variations of the display on the image data to increase the accuracy of object motion sensing for motion control.

Embodiments of the invention relate generally to electronic systems and, more particularly, to a system and method for performing motion control.

Motion controllable systems use object motion information, such as human gestures and machinery movements, to control their operations. For example, motion controllable systems may deploy motion detection sensors, such as infrared sensors, ultrasonic sensors, and microwave sensors, to sense object motion and transform the sensed object motion information into electric control signals. Motion controllable systems may also utilize cameras to capture images to optically sense object motion. For example, motion controllable videogame consoles may use cameras to observe player motion in order to control a game, such as manipulating characters in the game, starting the game, pausing the game, and stopping the game. Additionally, motion controllable systems may output screen contents to a display, such as a television or a computer monitor.

A concern with conventional motion controllable systems that utilize cameras is that dynamic screen contents result in luminance changes of the display, which may influence surrounding luminance conditions and in turn may reduce the accuracy of object motion sensing in captured image data for motion control.

Thus, there is a need for a system and method for performing motion control that improves the accuracy of object motion sensing in captured image data for motion control.

A system and method for performing motion control measures an effect of luminance variations of a display on captured image data containing motion information with regard to brightness and adjusts the brightness of the image data to compensate the effect of the luminance variations of the display on the image data to increase the accuracy of object motion sensing in the captured image data for motion control.

In an embodiment, a motion controllable device includes a camera interface unit, a brightness calibration unit, a brightness compensation unit, a processing unit, and a display interface unit. The camera interface unit is configured to receive image data containing motion information from at least one camera. The brightness calibration unit is configured to measure an effect of luminance variations of a display on the image data with regard to brightness.

The brightness compensation unit is configured to adjust the brightness of the image data to compensate the effect of the luminance variations of the display on the image data. The processing unit is configured to process adjusted image data to produce screen contents in response to the motion information of the adjusted image data. The display interface unit is configured to output the screen contents to the display.

In an embodiment, a motion controllable system includes at least one camera, a camera interface unit, a brightness calibration unit, a brightness compensation unit, a processing unit, a display interface unit, and a controller unit. The at least one camera is configured to capture image data containing motion information. The camera interface unit is configured to receive image data containing motion information from the at least one camera. The brightness calibration unit is configured to measure an effect of luminance variations of a display on the image data with regard to brightness. The brightness compensation unit is configured to adjust the brightness of the image data to compensate the effect of the luminance variations of the display on the image data. The processing unit is configured to process adjusted image data to produce screen contents in response to the motion information of the adjusted image data. The display interface unit is configured to output the screen contents to the display. The controller unit is configured to allow a user to input information and interact with the screen contents.

In an embodiment, a method for performing motion control includes (a) receiving image data containing motion information from at least one camera, (b) compensating an effect of luminance variations of a display on the image data with regard to brightness, including adjusting the brightness of the image data, (c) processing adjusted image data to produce screen contents in response to the motion information of the adjusted image data, and (d) outputting the screen contents to the display.

Other aspects and advantages of embodiments of the present invention will become apparent from the following detailed description, taken in conjunction with the accompanying drawings, illustrated by way of example of the principles of the invention.

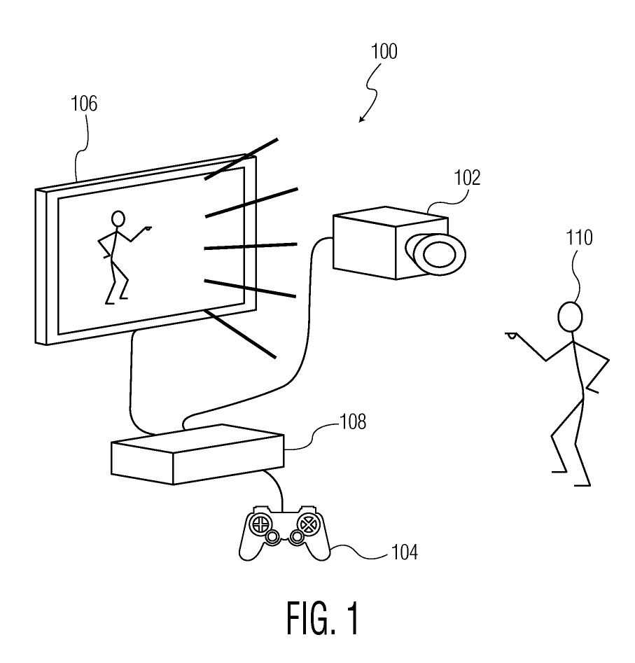

FIG. 1 is an illustration of a motion controllable system in accordance with an embodiment of the invention.

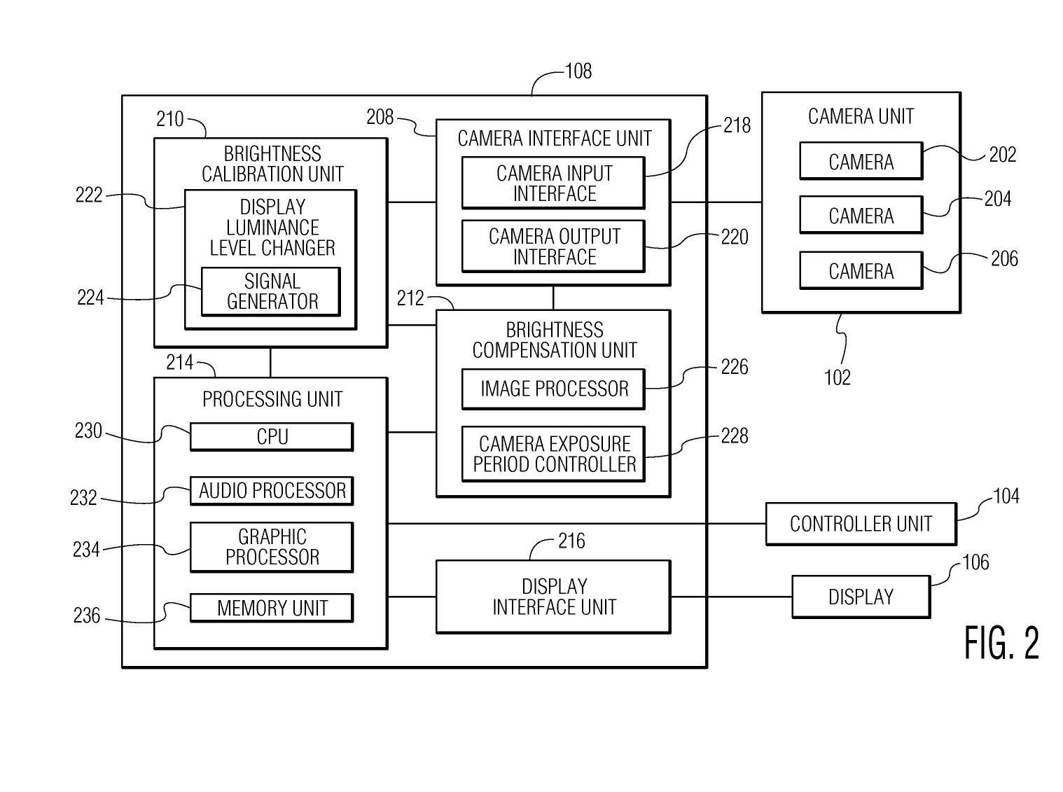

FIG. 2 is a schematic block diagram of the motion controllable system of FIG. 1.

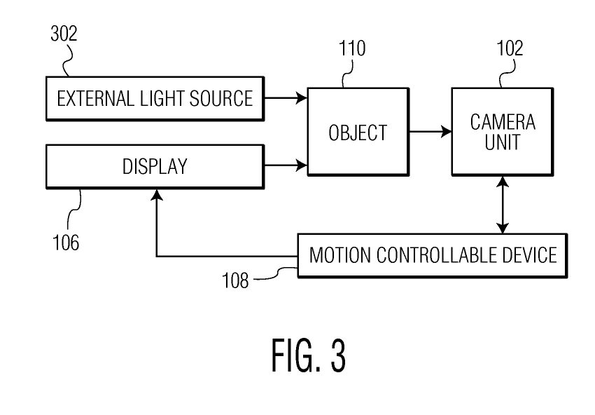

FIG. 3 is an illustration of brightness calibration and brightness compensation processes of the motion controllable system of FIG. 1.

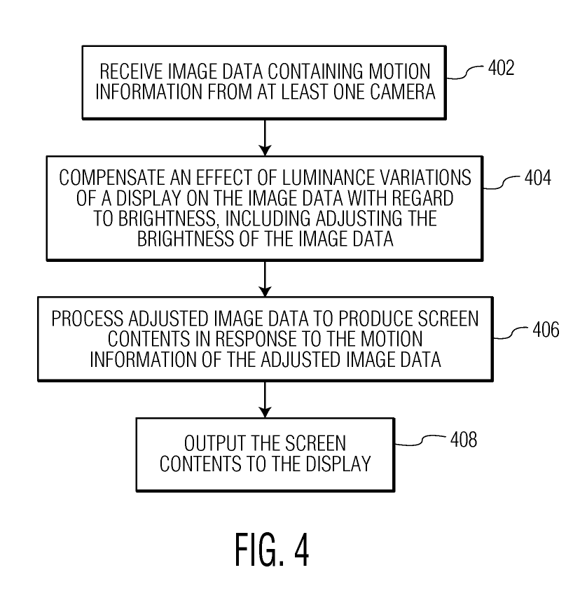

FIG. 4 is a schematic flow chart diagram of a method for performing motion control in accordance with an embodiment of the invention.

Throughout the description, similar reference numbers may be used to identify similar elements.

FIG. 1 is an illustration of a motion controllable system 100 in accordance with an embodiment of the invention. The illustrated system includes a camera unit 102, a controller unit 104, a display 106, and a motion controllable device 108. The illustrated system captures image data containing motion information of an object 110 using the camera unit, performs calibration to measure an effect of luminance variations of the display on the image data with regard to brightness, adjusts the brightness of the image data to compensate the effect of luminance variations of the display on the image data with regard to brightness, process the adjusted image data to produce screen contents in response to the motion information, and outputs the screen contents to the display. Although the depicted system includes several components described herein, other embodiments may include fewer or more components.

As shown in FIG. 1, the camera unit 102 includes a single camera that captures image data containing motion information of the object 110. However, in other embodiments, the camera unit may include more than one camera. Each camera of the camera unit may be a wireless camera or a wired camera. The controller unit 104 allows users to input information and interact with screen contents. As an example, the controller unit maybe a videogame controller. The display 106, which may be a television or a computer monitor, receives screen contents from the motion controllable device 108 and displays the screen contents.

In some embodiments, the display may be external to the system 100. The motion controllable device performs the calibration to measure the effect of luminance variations of the display on the image data captured by the camera unit with regard to brightness. The motion controllable device also adjusts the brightness of the image data to compensate the effect of luminance variations of the display on the image data with regard to brightness. The motion controllable device then processes the adjusted image data to produce screen contents in response to the motion information, and outputs the screen contents to the display. Turning now to FIG. 2, a schematic block diagram of the motion controllable system 100 of FIG. 1 is shown. Although the depicted system includes several functional blocks described herein, other embodiments may include fewer or more functional blocks to implement more or less functionality.

As shown in FIG. 2, the camera unit 102 includes three cameras 202, 204, and 206 that capture image data containing motion information of the object 110. Each of these cameras may be a wireless camera or a wired camera. Although the camera unit is shown with three cameras in FIG. 2, the camera unit may include fewer than three cameras or more than three cameras.

The motion controllable device 108 includes a camera interface unit 208, a brightness calibration unit 210, a brightness compensation unit 212, a processing unit 214, and a display interface unit 216. The camera interface unit includes a camera input interface 218 to receive image data containing motion information from the camera unit 102 and a camera output interface 220 to output control signals to one or more cameras 202, 204, and 206 of the camera unit.

The brightness calibration unit 210 includes a display luminance level changer 222 to change the luminance level of the display 106 during the calibration. The display luminance level changer includes a signal generator 224 to generate a plurality of signals for the display to sequentially produce a variety of luminance levels. The brightness calibration unit then measures an effect of luminance variations of the display on the image data captured by the camera unit 102 with regard to brightness. In the simplest form, the brightness calibration unit generates a plurality of signals for the display to sequentially produce only a high luminance level of the display and a low luminance level of the display in order to determine the extremes. In an embodiment, the high luminance level is produced by generating signals to display a completely white screen on the display and the low luminance level is produced by generating signals to display a completely black screen on the display. In a refined form, the brightness calibration unit sets some gradual steps between the high luminance level of the display and a low luminance level of the display not only to prevent annoying users with sudden flashes and triggering epileptic fits for some users but also to determine any non-linear effect of the luminance variations of the display on the image data containing motion information. The brightness calibration unit may be implemented in software, hardware, or a combination of software and hardware.

The brightness compensation unit 212 includes an image processor 226 and/or a camera exposure period controller 228. The brightness compensation unit adjusts the brightness of the image data captured by the camera unit 102 to compensate the effect of the luminance variations of the display 106 on the image data. The image processor performs image processing on the image data to adjust the brightness of received image data. The image processor may be implemented in software, hardware, or a combination of software and hardware.

The camera exposure period controller controls exposure periods of at least one camera of the cameras 202, 204, and 206 to adjust the brightness of the image data. The camera exposure period controller may be implemented in software, hardware, or a combination of software and hardware. Thus, the brightness compensation unit can adjust the brightness of the image data by performing image processing on the image data and/or changing the exposure periods of at least one of the cameras of the camera unit.

The processing unit 214 includes a central processing unit (CPU) 230, an audio processor 232, a graphic processor 234, and a memory unit 236. The processing unit processes the adjusted image data to produce screen contents in response to the motion information of the adjusted image data. The CPU receives motion control information or control commands from the controller unit 104, and instructs the audio processor and the graphic processor to produce audio signals and graphic signals, respectively. The audio processor and the graphic processor may be integrated with the CPU. The audio processor and the graphic processor may be implemented in software, hardware, or a combination of software and hardware. The memory unit may include random access memory (not shown) and/or a media module (not shown), which may be used to load pre-programmed motion controllable functions into the processing unit. The screen contents produced by the processing unit are outputted to the display 106 via the display interface unit 216.

The operation of the motion controllable system 100 includes a calibration process and a compensation process. During the calibration process, the brightness calibration unit 210 of the motion controllable system changes the luminance level of the display 106. The camera unit 102 of the motion controllable system then captures image data. The brightness calibration unit then measures an effect of luminance variations of the display on the image data with regard to brightness to determine a relationship between the luminance of the display and the brightness of the image data containing motion information.

During the compensation process, the camera unit captures image data containing motion information of an object, such as the object 110. The brightness compensation unit 212 of the motion controllable system then adjusts the brightness of the image data using the relationship between display luminance and image data brightness to compensate the effect of the luminance variations of the display on the captured image data. The processing unit 214 of the motion controllable system then processes the adjusted image data to produce screen contents in response to the motion information of the adjusted image data. The screen contents are outputted to the display via the display interface unit 216 to display the screen contents. The brightness calibration and brightness compensation processes are described in more detail below with reference to FIGS. 2 and 3.

As illustrated in FIG. 3, the lighting conditions on the object 110 being captured by the camera unit 102 of the motion controllable system 100 is dependent on the luminance of the display and the luminance of an external light source 302, which may includes sunlight, lamps, or a combination of sunlight and lamps. Thus, luminance variations of the display influences the lighting conditions on the object, and in turn reduce the perception of the camera unit to sense the motion of the object. It is assumed that the luminance of the external light source remains constant during a brightness calibration period, which lasts a short time, for example, a few seconds.

As shown in FIG. 3, the motion controllable device 108, the camera unit 102, and the display 106 form a loop. During a brightness calibration process, the brightness calibration unit 210 of the motion controllable device measures an effect of luminance variations of the display on captured image data with regard to brightness to determine a relationship between display luminance and image data brightness. During a brightness compensation process, the brightness compensation unit 212 of the motion controllable device adjusts the brightness of captured image data using the relationship between display luminance and image data brightness to compensate the effect of the luminance variations of the display on the captured image data.

A brightness calibration process of the motion controllable system 100 in accordance with an embodiment of the invention is now described. During the brightness calibration process, the display luminance level changer 222 of the brightness calibration unit 210 changes the luminance level of the display 106 by outputting screen contents with variant grayscale or brightness ranges.

In the simplest form, the brightness calibration unit 210 generates a plurality of signals for the display 106 to sequentially produce only a high luminance level of the display and a low luminance level of the display in order to determine the extremes. For example, the signal generator 224 of the display luminance level changer 222 generates signals to produce a first screen with the darkest grayscale level or a completely black screen. The camera unit 102 captures image data under the lighting conditions produced by the luminance of the external light source 302 and the luminance of the display with the darkest grayscale level. The image data is received by the brightness calibration unit through the camera input interface 218 of the camera interface unit 208. The brightness calibration unit compensates the latency of the loop formed by the motion controllable device, the camera unit, and the display. The brightness calibration unit then measures the brightness of the received image data, which may be the average grayscale value of pixels of the image data. The signal generator of the display luminance level changer then generates signals to produce a second screen with the lightest grayscale level or a completely white screen.

The camera unit captures image data under the lighting conditions produced by the luminance of the external light source 302 and the luminance of the display with the lightest grayscale level. The image data is received by the brightness calibration unit through the camera input interface of the camera interface unit. The brightness calibration unit again compensates the latency of the loop formed by the motion controllable device, the camera, and the display, which may be the average grayscale value of pixels of the image data. The brightness calibration unit measures the brightness of the received image data. With the assumption of a linear function, the relationship or function between the luminance of the display and the brightness of the image data can be determined

In a refined form, the brightness calibration unit 210 sets some gradual steps between the high luminance level of the display 106 and a low luminance level of the display, not only to prevent annoying users with sudden flashes and triggering epileptic fits for some users, but also to determine any non-linear effect of the luminance of the display on the brightness of captured image data. During each step, the signal generator 224 of the display luminance level changer 222 generates signals to produce a screen with a corresponding luminance level. The camera unit 102 captures image data under the lighting conditions produced by the luminance of the external light source 302 and the luminance of the display with the current luminance level. The image data is received by the brightness calibration unit through the camera input interface 218 of the camera interface unit 208. The brightness calibration unit compensates the latency of the loop formed by the motion controllable device, the camera, and the display. The brightness calibration unit then measures the brightness of the received image data. Through these steps, the function between the luminance of the display and the brightness of the image data can be determined.

A brightness compensation process of the motion controllable system 100 in accordance with an embodiment of the invention is now described. An optimal luminance of the display 106 for proper detection of motion information in the image data is selected by the brightness compensation unit 212 of the motion controllable device 108. The camera unit 102 captures image data containing motion information of an object, such as the object 110. The brightness compensation unit 212 of the motion controllable system then adjusts the brightness of the image data captured by the camera unit 102 to the optimal brightness using the function between the luminance of the display 106 and the brightness of the image data to compensate the effect of the luminance variations of the display on the captured image data. The luminance of the display is known to the brightness compensation unit since the motion controllable device provides screen contents to be displayed on the display. The brightness compensation unit can adjust the brightness of the image data by performing image processing on the image data and/or changing the exposure periods of at least one of the cameras 202, 204 and 206 of the camera unit to compensate for the difference between the current luminance of the display and the optimal luminance of the display.

FIG. 4 is a schematic flow chart diagram of a method for performing motion control in accordance with an embodiment of the invention. At block 402, image data containing motion information from at least one camera is received. At block 404, an effect of luminance variations of a display on the image data with regard to brightness is compensated, wherein the compensating includes adjusting the brightness of the image data. At block 406, adjusted image data is processed to produce screen contents in response to the motion information of the adjusted image data. At block 408, the screen contents are outputted to the display.

Although the operations of the method herein are shown and described in a particular order, the order of the operations of the method may be altered so that certain operations may be performed in an inverse order or so that certain operations may be performed, at least in part, concurrently with other operations. In another embodiment, instructions or sub-operations of distinct operations may be implemented in an intermittent and/or alternating manner Embodiments of the system and method for performing motion control can be applied to various electronic systems, in particular, video game electronic systems, fitness training electronic systems, and home electronic systems with gesture control feature.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A motion controllable device comprising:
a camera interface unit configured to receive image data containing motion information from at least one camera;
a brightness calibration unit configured to measure an effect of luminance variations of a display on the image data with regard to brightness;
a brightness compensation unit configured to adjust the brightness of the image data to compensate the effect of the luminance variations of the display on the image data;
a processing unit configured to process adjusted image data to produce screen contents in response to the motion information of the adjusted image data; and
a display interface unit configured to output the screen contents to the display.

2. The device of claim 1, wherein the brightness compensation unit is further configured to perform image processing on the image data to adjust the brightness of the image data.

3. The device of claim 1, wherein the camera interface unit is further configured to output control signals to at least one of the at least one camera.

4. The device of claim 3, wherein the brightness compensation unit is further configured to control at least one exposure period of the at least one camera using the control signals to adjust the brightness of the image data.

5. The device of claim 1, wherein the brightness calibration unit is further configured to change luminance levels of the display to measure the effect of the luminance variations of the display on the image data with regard to brightness.

6. The device of claim 1, wherein the brightness calibration unit is further configured to generate a plurality of signals for the display to sequentially produce only a high luminance level of the display and a low luminance level of the display to measure the effect of the luminance variations of the display on the image data with regard to brightness.

7. The device of claim 1, further comprising a controller unit configured to allow a user to input information and interact with the screen contents.

8. The device of claim 1, wherein the at least one camera includes at least one wireless camera.

9. A motion controllable system comprising:
at least one camera configured to capture image data containing motion information;
a camera interface unit configured to receive image data containing motion information from the at least one camera;
a brightness calibration unit configured to measure an effect of luminance variations of a display on the image data with regard to brightness;
a brightness compensation unit configured to adjust the brightness of the image data to compensate the effect of the luminance variations of the display on the image data;
a processing unit configured to process adjusted image data to produce screen contents in response to the motion information of the adjusted image data;
a display interface unit configured to output the screen contents to the display; and
a controller unit configured to allow a user to input information and interact with the screen contents.

10. The system of claim 9, wherein the brightness compensation unit is further configured to perform image processing on the image data to adjust the brightness of the image data.

11. The system of claim 9, wherein the camera interface unit is further configured to output control signals to at least one of the at least one camera.

12. The system of claim 11, wherein the brightness compensation unit is further configured to control at least one exposure period of the at least one camera using the control signals to adjust the brightness of the image data.

13. The system of claim 9, wherein the brightness calibration unit is further configured to change luminance levels of the display to measure the effect of the luminance variations of the display on the image data with regard to brightness.

14. The system of claim 9, wherein the brightness calibration unit is further configured to generate a plurality of signals for the display to sequentially produce only a high luminance level of the display and a low luminance level of the display to measure the effect of the luminance variations of the display on the image data with regard to brightness.

15. A method for performing motion control comprising:
receiving image data containing motion information from at least one camera;
compensating an effect of luminance variations of a display on the image data with regard to brightness, including adjusting the brightness of the image data;
processing adjusted image data to produce screen contents in response to the motion information of the adjusted image data; and
outputting the screen contents to the display.

16. The method of claim 15, further comprising measuring the effect of the luminance variations of the display on the image data with regard to brightness.

17. The method of claim 16, wherein measuring the effect of the luminance variations of the display on the image data with regard to brightness comprises changing luminance levels of the display.

18. The method of claim 16, wherein measuring the effect of the luminance variations of the display on the image data with regard to brightness comprises generating a plurality of signals for the display to sequentially produce only a high luminance level of the display and a low luminance level of the display.

19. The method of claim 15, wherein adjusting the brightness of the image data to compensate the effect of the luminance variations of the display on the image data comprises performing image processing on the image data.

20. The method of claim 15, wherein adjusting the brightness of the image data to compensate the effect of the luminance variations of the display on the image data comprises controlling at least one exposure period of the at least one camera.
